(19) United States
(12) Patent Application Publication
(10) Pub. No.: US 2006/0190991 A1
(43) Pub. Date: Aug. 24, 2006

(54) System and method for decentralized trust-based service provisioning

(76) Inventor: Pradeep J. Iyer, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/063,305

(22) Filed: Feb. 22, 2005

(51) Int. Cl. H04L 9/32

(52) U.S. Cl. 726/3

(57) ABSTRACT

In one embodiment of the invention, a network is adapted with a wireless network switch in communication with a plurality of access points, which are in communication with one or more wireless units. A guest user is provided access to the network by a wireless unit of an authorized user transmitting a first message to a targeted server of the network. The first message is configured to provision access to a network for the guest user. After generation of the guest password, it is subsequently provided to the guest user for authentication purposes. This enables guest access to be provisioned without any need of centralized control by an administrator.

### FIELD

Embodiments of the invention relate to the field of wireless communications, in particular, to a decentralized technique for provisioning services through trust-based operations.

### GENERAL BACKGROUND

Over the last decade or so, businesses have begun to install enterprise networks with one or more local area networks in order to allow their employees to share data and improve work efficiency. To further improve work efficiency, various enhancements have added to local area networks. One enhancement is remote wireless access, which provides an important extension in forming a wireless local area network (WLAN).

A WLAN supports wireless communications between wireless units and Access Points. Each Access Point independently operates as a relay station by supporting communications between wireless units of a wireless network and resources of a wired network. Currently, information technology (IT) administrators are responsible for provisioning services associated with the WLAN, including guest access.

Typically, IT administrators provide guest access over the WLAN according to one of three provisioning methods. A first provisioning method involves placement of the WLAN to be always active and open for guests to use. This guest provisioning method does not establish any user authentication or access control mechanisms. A second provisioning method involves alteration of encryption keys on a daily or weekly basis. The second guest provisioning method provides access control, but does not provide individual authentication. The third provisioning method involves the IT administrator creating a unique account for every guest. This supports authentication and access control, but is not scalable for large organizations where hundreds of different guests visit the organization on a daily basis.

### BRIEF DESCRIPTION OF THE DRAWINGS

The invention may best be understood by referring to the following description and accompanying drawings that are used to illustrate embodiments of the invention.

FIG. 1 is an exemplary embodiment of a network in accordance with the invention.

FIG. 2 is an exemplary embodiment of the WLAN switch of the network of FIG. 2.

FIG. 3 is an exemplary embodiment of a first method for provisioning services, such as guest access to the network of FIG. 1.

FIG. 4 is an exemplary embodiment of communications between a wireless unit and resources of the network in accordance with the first provisioning services method.

FIG. 5 is an exemplary embodiment of a second method for provisioning services, such as guest access to the network of FIG. 1.

FIG. 6 is a first exemplary embodiment of operations performed by the guest to access the network.

FIG. 7 is an exemplary embodiment of a third method for provisioning services, such as guest access to the network of FIG. 1.

FIGS. 8A is an exemplary embodiment of a first screen display for provisioning services in accordance with the third provisioning services method.

FIG. 8B is an exemplary embodiment of a second screen display for provisioning services in accordance with the third provisioning services method.

### DETAILED DESCRIPTION

Embodiments of the invention generally relate to a decentralized technique for provisioning services through trust-based operations, namely user authentication and access control. According to one illustrative embodiment, the technique would involve trust-based methods of operation where services, such as guest network access for example, are provisioned by an authorized user of the wireless network, without the need for centralized control by the IT administrator. Hence, trust is established for a wireless network in the same manner as the physical world where it is common for employees to sign temporary badges for non-employees when physically visiting a company.

Herein, the invention may be applicable to a variety of networks, including wireless networks such as a wireless local area network (WLAN) or wireless personal area network (WPAN). The wireless network may be configured in accordance with any current or future wireless communication protocol. Examples of various types of wireless communication protocols include Institute of Electrical and Electronics Engineers (IEEE) 802.11 standards, High Performance Radio Local Area Networks (HiperLAN) standards, WiMax (IEEE 802.16) and the like.

For instance, the IEEE 802.11 standard may include an IEEE 802.11b standard entitled “Wireless LAN Medium Access Control (MAC) and Physical Layer (PHY) specifications: Higher-Speed Physical Layer Extension in the 2.4 GHz Band” (IEEE 802.11b, 1999). Alternatively, or in addition to the IEEE 802.11b standard, the IEEE 802.11 standard may include one or more of the following: an IEEE 802.11a standard entitled “Wireless LAN Medium Access Control (MAC) and Physical Layer (PHY) specifications: High-Speed Physical Layer in the 5 GHz Band” (IEEE 802.11a, 1999); a revised IEEE 802.11 standard “Wireless LAN Medium Access Control (MAC) and Physical Layer (PHY) specifications” (IEEE 802.11, 1999); or an IEEE 802.11g standard entitled “Wireless LAN Medium Access Control (MAC) and Physical Layer (PHY) specifications: Further Higher Data Rate Extension in the 2.4 GHz Band” (IEEE 802.11g, 2003).

Certain details are set forth below in order to provide a thorough understanding of various embodiments of the invention, albeit the invention may be practiced through many embodiments other that those illustrated. Well-known logic and operations are not set forth in detail in order to avoid unnecessarily obscuring this description.

In the following description, certain terminology is used to describe features of the invention. For example, the term “logic” includes hardware and/or software module(s) configured to perform one or more functions. For instance, a “processor” is logic that processes information. Examples of a processor include a microprocessor, an application specific integrated circuit, a digital signal processor, a micro-controller, a finite state machine, a programmable gate array, or even combinatorial logic.

A “software module” is executable code such as an operating system, an application (e.g., browser), an applet or even a routine. Software modules may be stored in any type of memory, namely suitable storage medium such as a programmable electronic circuit, a semiconductor memory device, a volatile memory (e.g., random access memory, etc.), a non-volatile memory (e.g., read-only memory, flash memory, etc.), a floppy diskette, an optical disk (e.g., compact disk or digital versatile disc “DVD”), a hard drive disk, tape, or any kind of interconnect (defined below).

An “interconnect” is generally defined as an information-carrying medium that establishes a communication pathway. The interconnect may be a wired interconnect, where the medium is a physical medium (e.g., electrical wire, optical fiber, cable, bus traces, etc.) or a wireless interconnect (e.g., air in combination with wireless signaling technology).

“Information” is defined as data, address, control or any combination thereof. For transmission, information may be transmitted as a message, namely a collection of bits in a predetermined format.

I. General Architecture

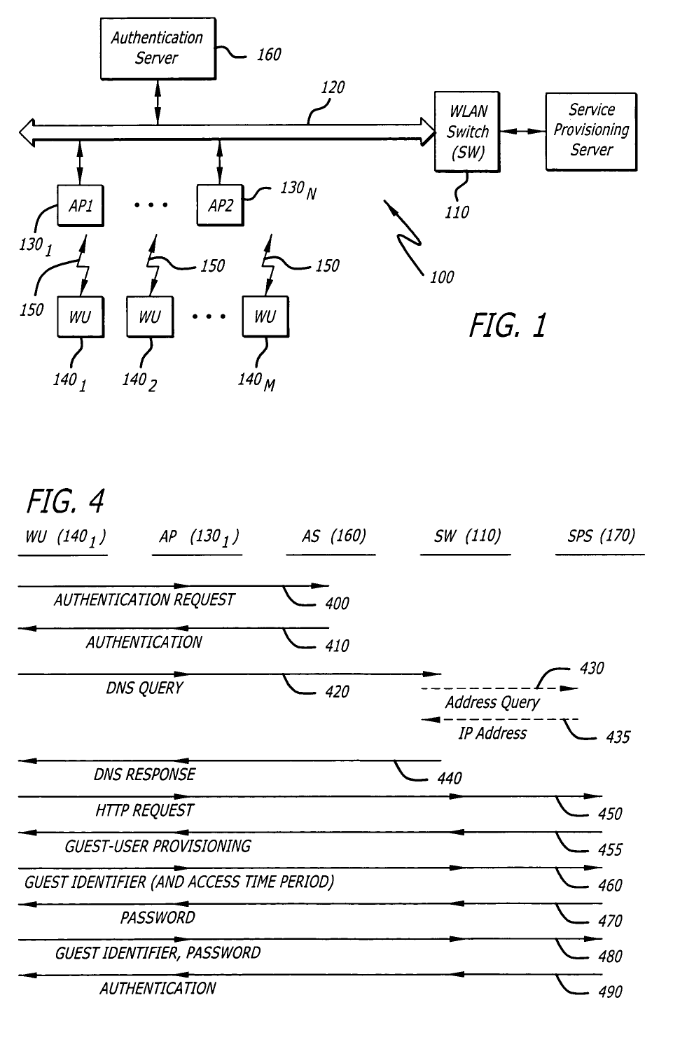

Referring to FIG. 1, an exemplary embodiment of a network 100 having a decentralized technique for provisioning services through trust-based operations is illustrated. According to this embodiment of the invention, network 100 is deployed as a wireless local area network (WLAN) that comprises one or more wireless network switches (e.g., WLAN switch 110) in communication with one or more access points (APs) 130₁-130_{N} (where N≧1) over an interconnect 120.

Interconnect 120 may be a wired or wireless information-carrying medium or even a mesh network for example. More specifically, interconnect 120 may be part of any type of private or public wired network, including but not limited or restricted to Ethernet, Token Ring, Asynchronous Transfer Mode (ATM), Internet or the like. The network communication protocol utilized over interconnect 120 may be selected from a variety of protocols, including TCP/IP.

In addition, network 100 further comprises one or more wireless units (WUs) 140¹-140^{M} (M≧1) in communication with APs 130₁-130_{N} over wireless interconnects 150. As shown, a wireless unit (e.g., WU 140₁) establishes communications with an AP (e.g., AP1 130₁), which enables WU 140₁ and its user to be authenticated by an authentication server 160. Authentication may be accomplished through a digital certificates or some sort of token-based authentication. Alternatively, authentication may be accomplished through a user name password scheme where authentication server 160 is a Remote Authentication Dial In User Service (RADIUS) server.

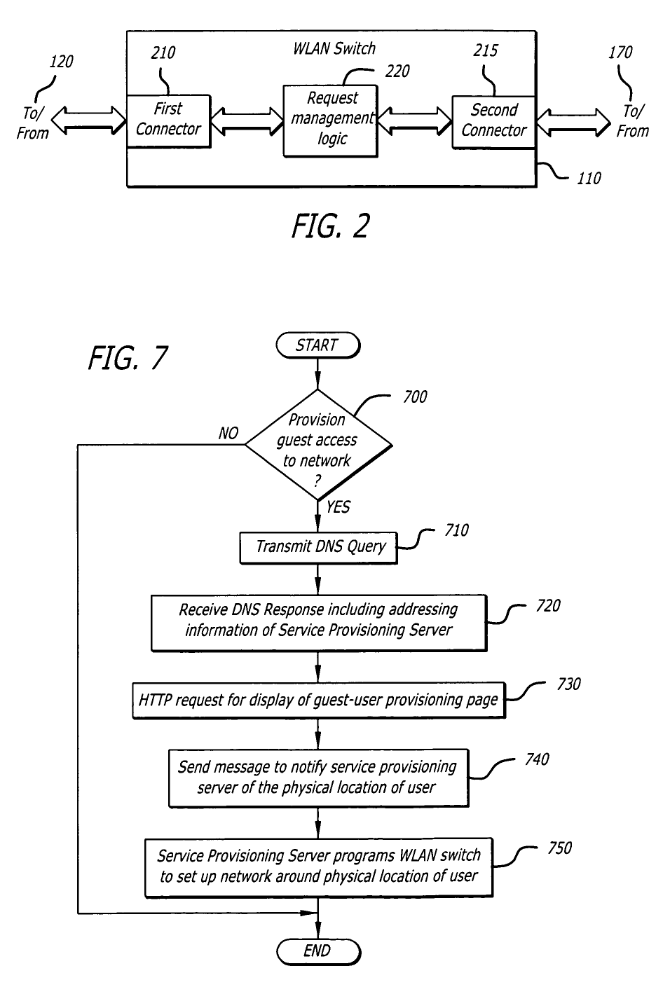

As shown in FIG. 1 and 2, WLAN switch 110 comprises logic 200 that supports bi-directional communications between a client (e.g., APs 130¹, . . . , and/or 130_{N} in communication with WU 140₁) and an Service Provisioning Server 170. Service Provisioning Server 170 is adapted to operate in combination with WLAN switch 110 to issue a DNS Response in response to a DNS Query from the client. The “DNS Response” message includes appropriate information (e.g., MAC or IP address of Service Provisioning Server 170) that will be recognized by the client to initiate a HTTP Request for information from the Service Provisioning Server 170 as discussed below.

More specifically, logic 200 of WLAN switch 110 comprises at least two connectors 210 and 215 as well as request management logic 220. A first connector 210 enables an exchange of information between request management logic 220 and interconnect 120. For instance, connector 210 may be adapted as Ethernet connectors, serial connectors or other types of connectors adapted for allows APs 130₁-130_{N} access to the request management logic 220. A second connector 215 enables an exchange of information between request management logic 220 and Service Provisioning Server 170.

Herein, request management logic 220 analyzes information associated with each DNS Query received by WLAN switch 110. According to one embodiment of the invention, request management logic 220 is implemented as a processor executing a program, stored in memory, which is configured to assist to identify DNS queries directed to particular uniform resource locators (URLS) as described below.

Referring back to FIG. 1, each AP 130₁, . . . , or 130_{N} supports bi-directional communications by receiving wireless messages from any or all of the WUs 140₁-140_{M} in its coverage area and transferring information from the messages over interconnect 120 to which WLAN switch 110 is coupled.

WU 140₁ is adapted to communicate with any associated AP. For instance, WU 140₁ is associated with AP 130₁ and communicates over the air in accordance with a selected wireless communications protocol. Hence, AP 130₁ generally operates as a transparent bridge connecting both network 100 featuring WU 140₁ with the wired network.

According to one embodiment, WU 140₁ comprises a removable, wireless network interface card (NIC) that is separate from or employed within a wireless device that processes information (e.g., computer, personal digital assistant “PDA”, telephone, alphanumeric pager, etc.). Normally, the NIC comprises a wireless transceiver, although it is contemplated that the NIC may feature only receive (RX) or transmit (TX) functionality such that only a receiver or transmitter is implemented.

II. Decentralized Trust-Based Service Provisioning

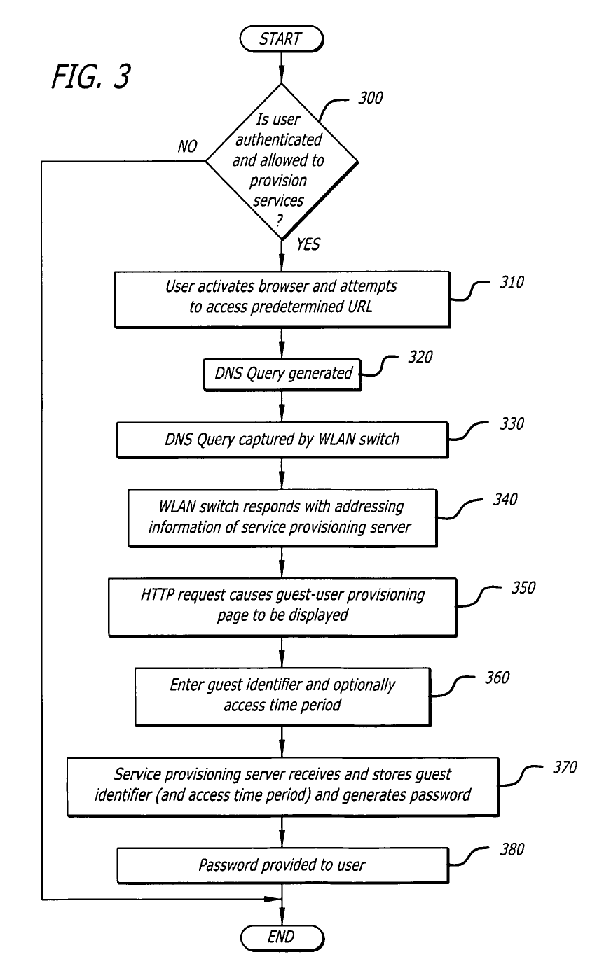

Referring now to FIG. 3, a first method for provisioning services, such as guest access to network 100 of FIG. 1, is shown. This provisioning service method initially determines if the user (or the wireless unit used by the user) is authenticated to provision particular services, and if so, supplies a password to be used by the guest user. A “guest user” may be a visitor, service provider, contract employee, or even an employee who is temporarily or permanently assigned a new role within the company and requires access to additional network services.

Initially, the user and/or the corresponding wireless unit is (are) authenticated by the network (block 300). If the user (or wireless unit) is not authenticated, the user will be prohibited from provisioning services. However, if the user and/or wireless unit is authenticated and authorized to provision certain services, the wireless unit initiates a message to a resource of the network. For instance, according to one embodiment of the invention, the user attempts to access a predetermined URL by activating a browser software module (block 310). The browser software module initiates a DNS Query by requesting access to the predetermined URL (block 320).

In communication with the wireless unit, an AP receives the message (e.g., DNS Query) and transfers the same to the WLAN switch (block 330).

Upon receiving the message and detecting that it is a particular type of message, such as receiving the DNS Query and detecting the selected DNS Query is directed to the predetermined URL for example, the WLAN switch returns a message (e.g., DNS Response) to the wireless unit via the AP (block 340). For one embodiment of the invention, the message may be a DNS Response message includes addressing information associated with a selected resource of the network such as the Service Provisioning Server. The addressing information enables a subsequent message (e.g., HTTP Request) from the wireless unit to be redirected to the Service Provisioning Server.

Upon receiving the DNS Response message, the wireless unit initiates a HTTP Request message to retrieve a guest-user provisioning web page from the Service Provisioning Server for display (block 350). The guest-user provisioning page is displayed by the wireless unit and allows the user to enter parameters used for provisioning certain services. As an example, one parameter may be an identifier of the guest user who will be provisioned guest access to the network (hereinafter referred to as a “Guest Identifier”). As an optional parameter, the user may be required to enter an “Access Time Period,” which identifies a period of time that the guest user is allowed access to the network (block 360).

The selected resource (e.g., Service Provisioning Server) receives the parameters in a new HTTP Request message for storage within an internal database of the selected resource (block 370). In addition, a password is generated and stored with the extracted parameters, such as the Guest Identifier for example. Moreover, the password is provided to the user for use in authenticating the guest user and establishing communications with the network (block 380).

Referring now to FIG. 4, an exemplary embodiment of communications between a wireless unit (WU 1401) and resources of network 100 of FIG. 1 in accordance with the service provisioning method of FIG. 3 is shown. The “arrowheads” illustrate receipt of a message by one of the components of network 100.

As described above, the user and/or WU 140₁ is (are) authenticated. This authentication involves transmission of an Authentication Request message to an AP (e.g., AP 130₁), which routes the Authentication Request message to WLAN switch, which in turn routes it to the authentication server 160 (operation 400). Where authentication server 160 is configured as a RADIUS server, the Authentication Request message may include a user name and a password established by the user. The provided information is compared to pre-stored information previously established by the user. Alternatively, the Authentication Request message may include a user name and a token to either identify WU 140₁ (e.g., digital certificate, pre-stored data such as a key, etc.) or identify the user (e.g., biometric scan, data from a portable token previously provided to the user, etc.).

Upon authentication of the user and/or WU 140₁ as shown in operation 410, the WU 140₁ initiates a DNS Query in response to execution of a browser software module and entry of a predetermined URL to access. The predetermined URL may be specific URL registered by the owner of the network or a company website (e.g., http://www.arubanetworks.com). AP 130₁ detects the DNS Query message so that it is available to WLAN switch 110 (operation 420).

Upon receiving and detecting the DNS Query is directed to the predetermined URL, WLAN switch 110 returns a DNS Response to AP 130₁ which is transmitted to WU 140₁ (operation 440). The DNS Response includes addressing information for redirecting a subsequent HTTP Request message to Service Provisioning Server 170. It is contemplated that the “addressing information” may include, but is not limited or restricted to an OSI Layer 3 address of Service Provisioning Server 170 (e.g., IP address) or perhaps its OSI Layer 2 address (e.g., Media Access Control “MAC” address).

In the event that WLAN switch 110 does not currently have immediate access to addressing information associated with Service Provisioning Server 170, WLAN switch 110 transmits an Address Query message to the Service Provisioning Server 170 to request addressing information (operation 430). Service Provisioning Server 170 provides the requested addressing information to the WLAN switch 110 (operation 435), which is used to form the DNS Response message described above.

Upon receiving the DNS Response message, WU 140₁ initiates a HTTP Request message to retrieve a guest-user provisioning web page from Service Provisioning Server 170 for display (operations 450 and 455). Although not shown, guest-user provisioning page comprises one or more entries: (1) an identifier for the guest user (Guest Identifier), and (2) an optional Access Time Period. The “Guest Identifier” is a substantially static parameter, which may be an electronic mail (e-mail) address for the guest user, his or her cellular phone number, a driver's license or other governmental identification source, a corporate badge number, or the like. The “Access Time Period” is a parameter that identifies a period of time that the guest user is allowed access to the network. The Access Time Period may be based on specific time measurements (e.g., minutes, hours, days, weeks) or may be set to an indefinite status until disabled by the user.

Service Provisioning Server 170 receives a message, including the Guest Identifier and optional Access Time Period, and adds the Guest Identifier (and optionally the Access Time Period) to an internal database stored therein (operation 460). In addition, a password is generated and stored with the authorized Guest Identifier as well as provided to the user for use in authenticating the guest user and establishing communications with the network (operation 470). According to one embodiment of the invention, the password is a random or pseudo-random value.

It is contemplated that access to the network by the guest user may be subsequently authenticated by either Service Provisioning Server 170 or authentication server 160. If the later, authentication server 160 would need to be provided with at least the Guest Identifier and the corresponding password.

Upon arrival of the guest user, the Guest Identifier and password are sent to either Service Provisioning Server 170 or authentication server 160 by the WLAN switch 110 to authenticate the guest user and allow access to the network (operations 480 & 490). For illustrative purposes, as shown in FIG. 4, Service Provisioning Server 170 authenticates the guest user. Authentication may involve comparing the Guest Identifier and password provided with the pre-stored information and, optionally, comparing the current time falls within the Access Time Period. It is contemplated that, once the Access Time Period has elapsed, access to the network can be terminated by signaling AP 130₁ to discontinue the current communication session with WU 140₁ and require re-authentication.

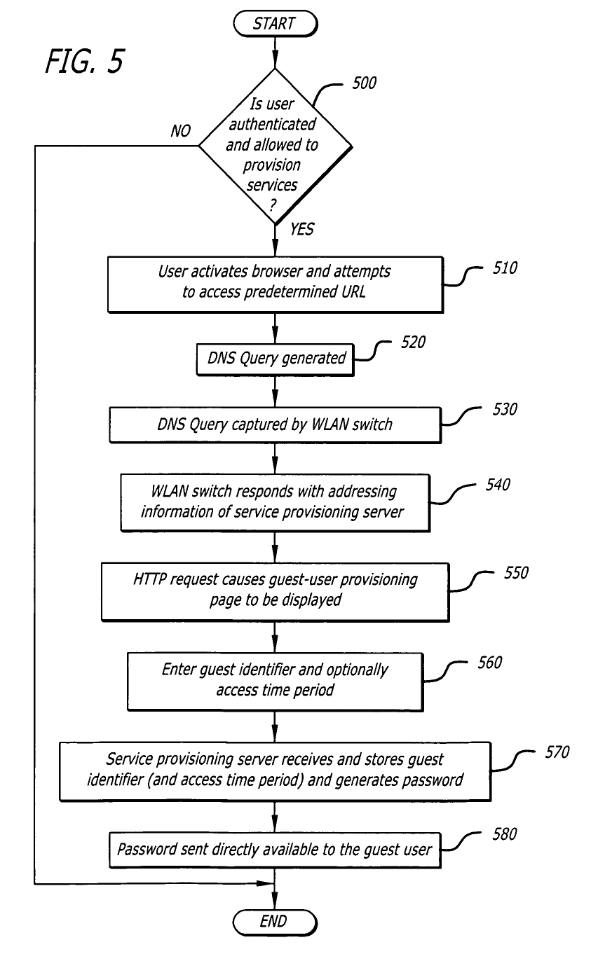

Referring now to FIG. 5, an exemplary embodiment of a second method for provisioning services, such as guest access to the network of FIG. 1. Similar to FIG. 3, the user (or his/her wireless unit) is authenticated (block 500).

After such authentication, the wireless unit initiates a DNS Query in response to execution of a browser software module and selection of a predetermined URL (blocks 510-520). The DNS Query is transferred from an AP in communication with the wireless unit and received by the WLAN switch (block 530).

Upon receiving the DNS Query and detecting that the DNS Query is associated with the predetermined URL, the WLAN switch either (i) returns a DNS Response with addressing information associated with the Service Provisioning Server to the AP for subsequent transmission to the wireless unit, or (ii) queries the Service Provisioning Server for the addressing information (block 540). The addressing information is used to redirect a subsequent HTTP Request message to the Service Provisioning Server.

Upon receiving the DNS Response message, the wireless unit initiates a HTTP Request message to retrieve a guest-user provisioning web page from the Service Provisioning Server for display (operation 550). The web page enables the user to enter multiple parameters used for authentication and access control. For instance, as described above, the parameters may include the Guest Identifier and the Access Time Period (block 560).

Upon receiving a transmitted message including the entered parameters of the guest-user provisioning web page after entry by the user, Service Provisioning Server 170 extracts at least the Guest Identifier parameter and stored the extracted parameter(s) within an internal database (block 570). In addition, a password is generated and stored with the authorized Guest Identifier parameter within the internal database.

Where the Guest identifier is an email address, an email message including the password is also transmitted to this listed e-mail address (block 580). Where the Guest identifier is a telephone number, the password is transmitted in alphanumeric text (if telephone has text messaging service) or as a recorded audio message featuring the password. Of course, in lieu of direct transmission, the password may be posted on a website to which access is controlled so that only the guest user is able to view the password.

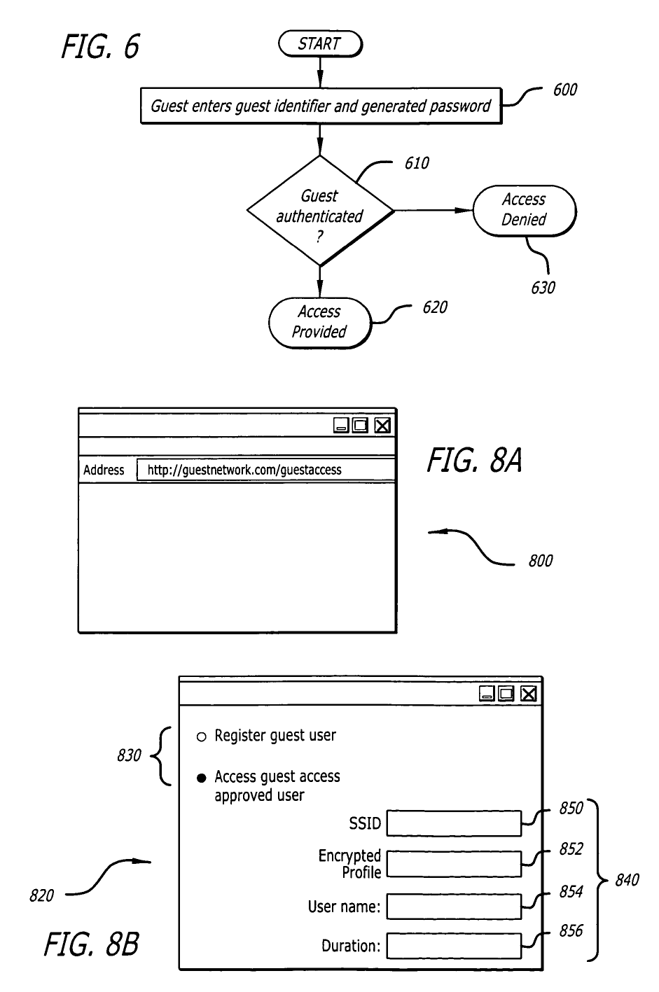

Referring now to FIG. 6, an exemplary embodiment of operations performed by the guest to access the network is shown. Since the guest user has both the Guest Identifier and the password in his or her possession, the guest user attempts to log onto the network by entering at least the Guest Identifier and the password (block 600). The Account Time Period parameter may be entered to provide an access control.

The Service Provisioning Server receives the entered information and compares the same with pre-stored information. If a match is detected, the user is authenticated and access is provided (blocks 610 and 620). If no match is detected, the user is not authenticated and access to the network is denied (blocks 610 and 630).

Referring to FIG. 7, an exemplary embodiment of a third method for provisioning services, such as guest access to network 100 of FIG. 1 is shown. First, a user attempts to provision services, such as guest access to the network, by first accessing the network (block 700). This operation authenticates the user to verify that the user is authorized to provision services. After being authenticated and determined to be authorized to provision services, the user causes his wireless unit to generate a message, such as a DNS Query to gain access to a predetermined URL as shown in display screen 800 of FIG. 8A. Of course, other message types may be used besides DNS Query.

Upon receiving and detecting the DNS Query is directed to the predetermined URL, the WLAN switch operating in cooperation with the Service Provisioning Server, returns a DNS Response to the AP, which is transmitted to WU 140₁ (blocks 710 and 720). The DNS Response includes addressing information for redirecting a subsequent HTTP Request message to the Service Provisioning Server.

Upon receiving the DNS Response message, the wireless unit initiates a HTTP Request message to retrieve a guest network provisioning web page from the Service Provisioning Server for display (block 730). The guest network provisioning web page is configured with a plurality of entries into which the user inputs parameters used to formulate the wireless sub-network.

As an example, the guest network provisioning web page 820 is shown in FIG. 8B, and includes a first setting parameter 830 to enable registration of the guest user (described in FIGS. 3 & 5) and to formulate a wireless sub-network around the user. Upon selecting the wireless sub-network setting, guest network provisioning page 820 further provides entries 840 for the user to supply parameters to establish the wireless sub-network. For instance, as an example, the user may be required to enter a SSID of the AP or any neighboring APs to which the guest user has access into a first entry 850. It is contemplated, however, that the SSID of the AP to which the wireless unit of the user communicates may be automatically loaded into the first SSID entry 850 for ease of use.

In addition, guest-user provisioning page 820 may include a plurality of additional entries including the following: a second entry 852, which enables the user to identify any encryption profiles (e.g., keys, etc.) for the sub-network; a third entry 854 to include one or more user names for the guest users (e.g., e-mail addresses or other substantially static data corresponding to the user during his or her access to the network); and a fourth entry 856, which enables the user to limit the duration of operation of the sub-network (also referred to as the “Access Time Period” described above).

The basis for the message is to notify the Service Provisioning Server of the location of the user and to enable the Service Provisioning Server to program the WLAN switch to restrict access by the guest user to only the AP or perhaps neighboring APs (blocks 740 and 750). For instance, the Service Provisioning Server may be adapted to program WLAN switch to activate of two APs to which the guest user has access to and to allow access to all resources or to restrict access to only the WLAN switch to enable access to a public network (e.g., Internet) or to specific resources. The AP or APs may be adapted to cover only a specific small area, such as the confines of a conference room, lobby and the like.

While the invention has been described in terms of several embodiments, the invention should not limited to only those embodiments described, but can be practiced with modification and alteration within the spirit and scope of the appended claims. For instance, the provisioning of services is described as originating from a wireless unit. It is contemplated, of course, that a wired device may be used by the user to provisioning services. Hence, no communications are required through the AP as shown. The description is thus to be regarded as illustrative instead of limiting.

What is claimed is:

1. A method comprising:
transmitting a first message to a server from an authorized user in order to provision access to a network by a guest user without any need of centralized control by an administrator, the first message including a guest identifier;
receiving a guest password from the server for subsequent use by a guest user;
authenticating the guest user using the guest identifier and the guest password; and
allowing the guest user access to the network if the guest user is authenticated.

2. The method of claim 1, wherein the first message is a HTTP Request in response to receiving addressing information associated with the server from a wireless local area network (WLAN) switch.

3. The method of claim 1, wherein prior to transmitting the first message, the method further comprises:
transmitting a DNS Query message from a wireless unit to an access point;
routing the DNS Query message from the access point to a wireless local area network (WLAN) switch;
routing a DNS Response message, including the addressing information associated with the server, from the WLAN switch to the wireless unit; and
exchanging messages between the wireless unit and the server to generate the first message.

4. The method of claim 1, wherein the exchange of messages comprises:
transmitting a HTTP Request message to download a display page from the server; and
displaying the display page for the authorized user to enter the guest identifier being part of the first message.

5. The method of claim 1, wherein the receiving of the guest password further comprises displaying the guest password for the authorized user to provide to the guest user.

6. The method of claim 1, wherein authenticating the guest user comprises
entering an identifier for the guest user and a password for the guest user at the wireless unit;
transmitting the identifier and the password for the guest user to the server;
comparing the identifier and the password for the guest user with the guest identifier and the guest password; and
authenticating the guest user if the identifier matches the guest identifier and the password matches the guest password.

7. The method of claim 1, wherein the first message further comprises an access time period being a parameter that identified a period of time that the guest user is allowed access to the network.

8. A method for provisioning services through trust-based operations, comprising:
initiating a request for a service to be provisioned for a guest user, the request including a guest identifier and an access time period being a parameter to identify a period of time that the guest user is provisioned the service;
receiving a guest password in response to the request;
requesting the service by the guest user by providing the guest identifier and the password; and
authenticating the guest user using the guest identifier and the guest password with the guest user provisioned with the services upon authentication.

9. The method of claim 8, wherein the request is a first HTTP Request in response to receiving addressing information associated with a server from a wireless local area network (WLAN) switch.

10. The method of claim 9, wherein prior to initiating the request, the method further comprises:
transmitting a DNS Query message from a wireless unit to an access point;
routing the DNS Query message from the access point to a wireless local area network (WLAN) switch;
routing a DNS Response message, including the addressing information associated with the server, from the WLAN switch to the wireless unit; and
exchanging messages between the wireless unit and the server to generate the request.

11. The method of claim 10, wherein the exchange of messages comprises:
transmitting a second HTTP Request message to download a display page from the server; and
displaying the display page for an authorized user to enter the guest identifier being part of the request.

12. The method of claim 8, wherein the receiving of the guest password further comprises displaying the guest password to be subsequently provided to the guest user.

13. The method of claim 8, wherein the receiving of the guest password further comprises transmitting the guest password to the guest user using the guest identifier.

14. The method of claim 8, wherein authenticating the guest user comprises
entering an identifier for the guest user and a password for the guest user at the wireless unit;
transmitting the identifier and the password to the server;
comparing the identifier and the password with the guest identifier and the guest password; and
authenticating the guest user if the identifier matches the guest identifier and the password matches the guest password.

15. The method of claim 8, wherein the request further comprises an access time period being a parameter that identified a period of time that the guest user is allowed access to the network.

16. A method comprising:
notification of a server of a location of an authorized user of a network; and
programming a wireless network switch to restrict network access by a guest user to one or more access points physically proximate to the location of the user.

17. The method of claim 16, wherein the programming of the wireless network switch includes activation of a plurality of access points covering the location of the authorized user and allowing access to resources of the network while the guest user is within the location and preventing access by the guest user to the network when leaving the location.

18. The method of claim 16, wherein the programming of the wireless network switch includes activation of a plurality of access points covering the location of the authorized user and allowing access to only a public network while the guest user is within the location.
